(19) United States
(12) Patent Application Publication
(10) Pub. No.: US 2026/0330070 A1
(43) Pub. Date: Oct. 22, 2026

(54) Devices and Methods for the Detection of Counterfeit and Defective Electronic Components UsingMachine Learning

(71) Applicant: Mobius Materials, Inc., Richmond, VA (US)

(72) Inventors: Margaret Upshur, Richmond, VA (US); Will Inigo, San Francisco, CA (US)

(73) Assignee: Mobius Materials, Inc., Richmond, VA (US)

(21) Appl. No.: 19/365,690

(22) Filed: Oct. 22, 2025

Related U.S. Application Data
(60) Provisional application No. 63/710,524, filed on Oct. 22, 2024.

(51) Int. Cl. G06F 21/73; G01G 23/42; G06V 10/141

(52) U.S. Cl. CPC G06F 21/73; G01G 23/42; G06V 10/141

(57) ABSTRACT

Counterfeit microelectronics have been estimated to cause more than $250 billion dollars of damage^{⊥} annually to commercial and government entities, including threatening national security. Traditional methods of detection are not sufficient as they take too long, are expensive, are destructive to the tested devices or are not flexible enough for many device types. This technology addresses and detects recycled and remarked counterfeits without the need for destructive tests. Optical analysis when coupled with other sensor data can reveal anomalies between an authentic and a counterfeit device in a quick handheld test without destroying the device under test (DUT). This data can be analyzed by several machine learning algorithms to indicate whether a component is considered counterfeit.

### FIELD OF THE INVENTION

The invention pertains to electronic components and methods for identification of counterfeit electronic components and for confirmation that electronic components are authentic. More specifically, the invention pertains to authentication of electronic components.

### BACKGROUND

There is a need for electronics manufacturers and electronic product manufacturers to have methods and devices capable of detecting whether an electronic component is authentic, counterfeit, and/or defective.

Counterfeit electronics are a large and growing problem in global supply chains for electronics manufacturers. A metastudy found that consumer and industrial businesses are losing approximately $250 billion each year due to the purchase of counterfeit electronic components including computer chips. After manufacturing and incorporation into downstream products, counterfeit or defective chips can cause the entire product to fail, resulting in safety issues and/or loss of value. In addition, experts reported that ~15% of the spare and replacement parts the Pentagon bought in the market were counterfeit, a major threat to national security. However, existing anti-counterfeiting methods are impractical. Current techniques are based on either slow electrical testing, subject matter expert (SME) analysis or expensive large equipment (e.g., X-Rays).

Current industry methods for determining whether an electronic component is authentic involve a costly, labor intensive procedure that has to be performed by highly trained counterfeit detection technicians on expensive equipment, often destroying the device under test (DUT) in the process.

These conventional methods have several issues. Firstly, as there are differences in how each technician interprets the test results and there is discretion in accepting or rejecting a chip or electronic component, the process is subject to human error. Secondly, these methods take significant time to ship the components to specialized centers. Counterfeit detection labs test components on many pieces of equipment valued in the tens of thousands of dollars. These conventional methods cost up to $5,000 per tested batch because of the time spent by trained lab workers and the use of expensive equipment. Finally, only a small number of chips can be tested and many of those that are tested are destroyed in the testing process. This means that if a given set of components had only 10% counterfeits mixed, it is unlikely they could be identified.

### SUMMARY

This invention uses a visual and mass-based inspection and an electronic assessment to make a digital fingerprint with hundreds of individual data points of the characteristics of an authentic electronic component or chip. As used herein, chip and electronic component are used interchangeably. Embodiments of the device and method may then automatically identify if a component is in a tolerance range of the digital fingerprint and rejects or accepts the component. The cost of our solution will be in the hundreds of dollars range as compared to price tags of greater than $25K for some counterfeit detection machines.

In an embodiment of our machine learning solution, the method comprises moving images through a segmentation model as an initial processing step to determine more about components before putting them through our primary classifier. Second, embodiments of the method may comprise using additional sensor inputs like spectral analysis and an ambient light sensor to find tricky features such as engraving depth and exact color. And third, embodiments of the method may comprise using a combination of a supervised binary classifier and an unsupervised anomaly detection model so the device and method can make classifications of “Authentic” on electronic components without having trained the data on anything other than software-generated counterfeits.

### DESCRIPTION OF THE FIGURES

FIG. 1 shows a possible flow of machine learning models of the device. (A) is the physical device and measurement step. (B) and (C) are the image normalization and image segmentation steps respectively. These will process the images to generate features. The output of this step is a normalized image with the pins, labels and body of a component segmented. Feature generation will be processing of the raw data into information for the models (D) and (E) is a supervised model that will determine if the chip is Authentic or Not Authentic. Next, the device and method may send the normalized and segmented images into the unsupervised anomaly detection model (F). (G) is the final step, in which we will assess the probabilities of both models and apply a classification threshold to create a class label of Authentic or Not Authentic;

FIG. 2 depicts a prototype of the device. There is a camera mounted on the top of the enclosure. There is lighting throughout the enclosure inside. There is a control board to the right of the enclosure that handles interaction with the user. There is also a scale at the bottom of the enclosure that has a load cell exposed to the device; and

FIG. 3 shows the electrical measurement interface. There is a lever arm that presses the chip down into a matrix of connecting pads. These sit on a padded platform. Each pad is connected with a wire to the control board.

### DESCRIPTION

Embodiments of the devices and methods for the detection of counterfeit and defective electronic components using machine learning may comprise some or all of the following steps in any order:
1. Component enters or is placed in the machine.
2. Operator enters any metadata or scans a code to enter the metadata into the device memory or cloud database about the test run including at least one of a lot number, lot size, invoice number, date, condition, operator name or other items, for example.
3. Operator initiates the test.
4. The device may coordinate lighting, engage a digital imaging device to produce a raw image file, and a scale to measure the weight of the component. The machine may also be configured to measure proximity (via an IR proximity sensor) and spectrum analysis for color (via an ambient light and spectral analysis chip).
5. The device may send data from the tested component to a processing unit in the cloud, other networked computer, or use an internal processing unit to compare the measured data to that of a known good component or compare the data in its memory.
   a. The software may perform several intermediary functions, if desired, including but not limited to:
      i. Raw image processing—e.g., crop, rotate, as well as other processes, if applicable;
      ii. Segmentation of the chip image into elements including, but not limited to, pins, background, package, and text via a machine learning model, for example; and/or
      iii. Optical character recognition (OCR) on the label of the chip.

As described above, the processing unit is in communication with a database of chip, component or board information. The chip, component, or board information includes information that defines the authenticity and functionality. This information may include, but is not limited to, at least one of a chip identification code of the authentic electronic component, a weight range of the authentic electronic component identified by the chip identification code, a color range of the authentic electronic component identified by the chip identification code, label information of the authentic electronic component identified by the chip identification code, label placement coordinates of the label on the authentic electronic component identified by the chip identification code, a size of the authentic electronic component identified by the chip identification code, a size of various elements of the authentic electronic component identified by the chip identification code, for example.

The chip, component, or board information may further include, but are not limited to, various elements that define the chip, component, or board a length, width, and height of a body, the label, characters of the label, a depth of the characters of the label, pins, solder residue, or other features of the authentic electronic component.
6. Embodiments of the device and method may use the following validator information and methods in this order to identify if the chip is genuine:

| | Name | Measurement | Input data | Algorithm |
|---|---|---|---|---|
| 7.1 | Weight | Scale | Weight | Compare weight to good chip with tolerance |
| 7.2 | Color | Photo | Processed | Compare color to good chip with tolerance |
| | | | image | |
| 7.3 | Label | Photo | Segmented | Compare center to center of good chip with |
| | Placement | | image | tolerance |
| 7.4 | Total size of | Photo | Segmented | Compare pixels of each element type to good |
| | elements | | image | chip |
| 7.5 | Image segment | Photo | Segmented | Compare pixels of each element type to good |
| | ratios | | image | chip |
| 7.6 | Label font | Photo | Segmented | Machine learning on images |
| | | | image | |
| 7.7 | Label | Photo | Processed | Machine learning on images. This method |
| | engraving | | image | uses the shadow on photos taken at different |
| | depth | | | angles to determine the depth of engraving. |
| 7.8 | Depth of chip | Photo | Processed | Machine learning on images. This method |
| | | | image | uses the shadow on photos taken at different |
| | | | | angles to determine the depth of the chip. |
| 7.9 | Pin damage | Photo | Segmented | Machine learning to identify what is solder |
| | | | image | vs, not and pin angles are correct (e.g., not |
| | | | | bent) |
| 7.10 | Label content | Photo | Image with | Compare expected static text (e.g., without |
| | | | OCR | variable serial numbers) to chip |
| 7.11 | Electrical | Voltage | Voltage | Series of electrical waves and input/output |
| | function | | pattern | voltages are applied to pins, the output |
| | | | | voltages are measured and compared to the |
| | | | | output |
| 7.12 | Texture and | Photo | Processed | Anomaly detection model |
| | ghost markings | | image | |
| 7.13 | Solder residue | Photo | Processed | Anomaly detection model |
| | | | image | |

7. If enough validators fail (are not within defined specifications or tolerances for the authentic component) or specific validators fail, then the chip or other component will be rejected, and an indicator will alert an operator or take some other action to indicate that the chip or other electronic component is defective or counterfeit. If all validators are considered to be within tolerances or otherwise successful, then the chip will be accepted, and an approval of the chip or other electronic component will be indicated.
8. The metadata and/or measured information of the chip may be posted to the cloud or a database on the device or other remote location and used in a variety of ways including, but not limited to:
1. Creating a “fingerprint” including specifications and tolerances of the data of a known “good” or authentic chip;
2. The approved chips may be automatically posted to a marketplace for resale;
3. Recording serial numbers of the failed and authenticated chips or components in a database;
4. Creating, maintaining and revising metrics on inbound quality of chip supply for each component or chip;
5. Adding chip data to a database which may be used to improve validation procedures;
6. Developing; maintaining; and improving a “trust score” for the supplier of the chips; and
7. Determining the value and condition of the chips based upon prior sales, current market; and/or condition of the chip or component.
Machine Learning Steps

The device and method may include machine learning based upon the information gathered during testing. For example, for each difference (measured value compared to the specifications and tolerances), the method may compare the value universally (e.g., across many chips) or on a SKU-basis (meaning that comparing with only the same part number by the same manufacturer), or both. For example, bent and corroded pins may be determined based upon and identifiable by a single machine learning algorithm across multiple SKUs having similar pins designs.

Label locations, on the other hand, may be located at various locations on different chips based upon chip or components size and manufacturer. Labels may be in the same location only for the same SKU or across a few SKUs. The device and method may use the universal method to determine Authentic or Not Authentic score for common features or differences, this score will be more accurate because the device and method may use a much larger data set than just the values available for a single SKU. For SKU-based differences, the device and method may generate a comparison model for each SKU (a unique manufacturer, part combination).

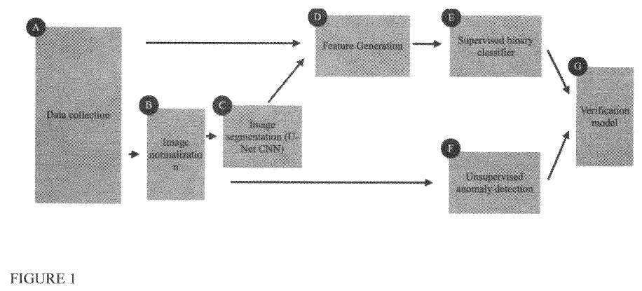

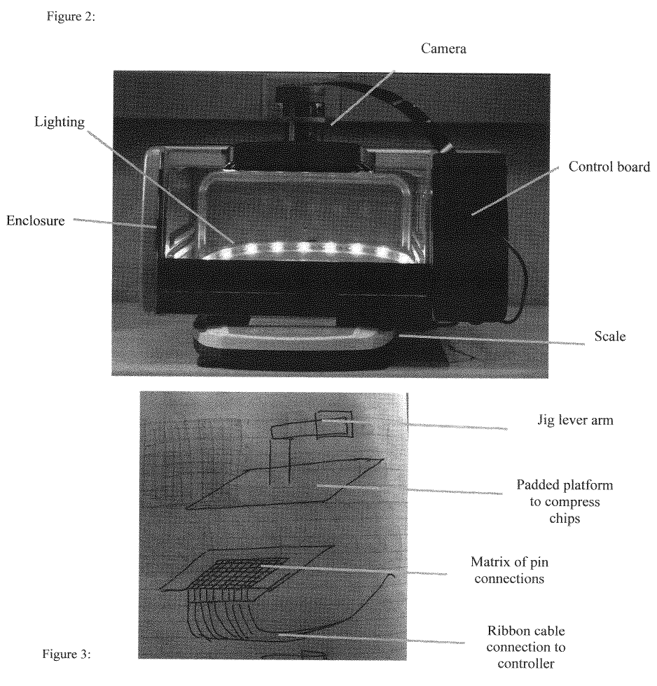

In order to capture the differences above, embodiments of the method may comprise (one or more of the following steps as depicted in FIG. 1) obtaining an image, processing the image by measuring portions of the image such as the chip to be assessed, proximity (via an IR proximity sensor), and spectrum analysis for color (via an ambient light and spectral analysis chip, for example). Embodiments of the device may comprise a camera, camera mounting system, and camera control module configured to take basic stationary images at the right resolution and right lighting source for single chips (A). The device and method may do the image normalization (B) and image segmentation model (C) that uses a U-Net convolutional neural network, for example. The output of this step is a normalized image with the pins, labels and body of an electronic component segmented.

Next, the method may comprise generating features using combinations of the sensor inputs and feeding specifications of the features into the supervised binary classifier (D and E). Next, the method may comprise sending the normalized and segmented images into the unsupervised anomaly detection model (F). G may be the final step, in which the method comprises assessing the probabilities of both models and applying a classification threshold to create a class label of Authentic or Not Authentic.

### Model E:

Type: Supervised binary classifier model where the target class is “Authentic” Returns: Likelihood that an unknown sample is included in the “Authentic” class.
   Algorithms that may be used in this step, for example:
A Logistic Regression model with L1 regularization
Support Vector Machine
XGBoost
Random Forest (RndF)
An anomaly detection algorithm as described by Model F

### Model F:

Type: Anomaly detection model with input of the segmented and raw images—Returns: Anomaly detection likelihood

Algorithms that may be used in this step, for example:
OneClassSVM
Robust Random Cut Forest
Isolation forest

The overall verification model and method will return an indication of False if either the binary classifier or the anomaly detection describes an anomalous condition. The best combination of models may be assessed by the one with the maximum area under the precision-recall curve (PR AUC), for example.

All methods and devices may also be configured and used to assess a PCBA or printed circuit board assembly to determine if it is acceptable. For example, the device and method may assess whether either 1) the overall structure of the board is correct or incorrect (e.g., placement of components, overall design, soldering, etc.) or 2) a specific chip on the board is counterfeit but the overall structure of the board is intact. Thus, the method may perform all checks above at the PCB level. In another embodiment, the method comprises subdividing the board or an image file of the board into chips and putting each chip image through the chip authenticity algorithm as described herein to determine its authenticity.

### Relationship Between Components

Additional embodiments of the method and the device may be used to determine whether a component is authentic and/or functional. Alternatively, the method and device may be used for a calibration run which will capture data about a chip that is known to be valid. In this case, steps 7.1 to 7.13 will be the same, but then the machine will only indicate that the process is complete and proceed to process its data instead of doing any validation steps (8.1 only), since the chip, component, or board is known to be authentic and functional.

The steps may be ordered to have the fastest and most definitive tests first, for example. This will improve the overall speed as the device and the method may make a determination that the chip, component, or board is most likely to be counterfeit or defective at any step after the chip or electronic component. For example, the weight test, for some components, may be the most effective; heat damage, plastic type discrepancies and most functional chip differences will alter the weight of the component and cause failure of this test conclusively.

Therefore, in some embodiments, a failure of the weight comparison test (step 7.1) is the simplest method of ascertaining whether a chip is not genuine or not functional. Weighing the component and comparing the weight to the weight range of an authentic functioning component is the least processing-intensive, fastest, and also quite effective. If that method fails to determine that the chip or component is out of specification, the visual tests in steps 7.2-7.5 may be performed as the next steps in the method.

These image processing steps may include a machine learning algorithm to run to segment the image file to make the image processing steps much more effective. These image processing steps are effective in finding counterfeits that have been created via blacktopping or printing of poor quality. However, visual methods cannot identify all defective authentic chips.

Therefore, the method or machine may include checks for pin damage or solder residue and, in some embodiments, the device or method may include a test to compare the text on the label to the expected text stored in the database.

Finally, an electrical test may be performed. At any point if a step fails, then the chip will be rejected. The electrical step (7.10) may be the most complicated step. The orientation of the chip may be visually mapped by using either the position of the positioning dot on the package or the lettering on the device. The algorithm identifies which of the pins of the component are attributed and/or electronically connected to each of the pins of the test rig bed. If any of the pins are misaligned such that the test may not be completed, the operator is alerted to rotate the chip to orient it correctly or the device may automatically align the chip with a matrix of pin connectors. The device may then apply a voltage to one or more pins of the chip according to a series of voltages determined earlier in the calibration of the good chip. For example, the good chip might have received the following where 1 indicates high voltage and 0 indicates low voltage.
Series input, Pin 1 [1, 0, 0, 1], Pin 2 [1, 1, 1, 0, 0]
Series 2 input, Pin 1 [1, 1, 1, 1], Pin 2 [1, 1, 1, 0]
   It then may have exhibited the following: expected output:
Series 1 output, Pin 3 [1, 1, 0, 1], Pin 4, [0, 0 0]
Series 2 output, Pin 3 [1, 0, 0, 1], Pin 4 [0, 0, 0, 0]

In this case, when testing the questionable chip, the machine will replicate the Series 1 and 2 inputs and listen for the Series 1 and 2 expected output. If there are delays in timing, variations in response or unexpected additional responses, the validation will fail. If all the output is as expected, the chip will pass. There may be many more input voltages included in each series and many more series of inputs included than the example above. The expected output may be on a chip by chip basis or on similarly related chips.

The calibration step for determining whether or not a component is authentic and functional involves identifying the correct set of input and output voltage series to use in validation. When a chip is entered for calibration, the machine may test multiple input and output pairings or series to determine authenticity and functionality. For example, some pins are power or output pins and, therefore, will not respond to input voltages. This means that feeding an input voltage to these pins will not generate meaningful output voltages. In the calibration step, the machine will pass in many more series of inputs than are needed in the final validation in order to find sequences that characterize the function of the chip and are non-trivial. It will store the final sequences in a database.

The input/output pairs to use on a component may be a secret key used for authentication. For example, the manufacturer may provide an “electronic hologram” of sorts to aid the validation of the chip. The manufacturer may program in a specific series of input voltages that trigger an unexpected output voltage series that may not be related to the function of the chip but a specific output may be used to validate it.

Embodiments of the method and device are meant to test electronic components in environments such as integrated circuits, passive components, and other embodiments of the device may be configured and used for any electronic component or chip.

Embodiments include a device or a machine that executes the above methods and steps automatically, a piece of software that runs the tests as above and an overall methodology for automatically checking authenticity and function of electronic components.

The machine is composed of several items or some of the following components: a camera or other digital imaging device, such as a digital camera with a macro lens, an enclosure that standardizes the lighting of the chip or electronic component, a series of individually addressable LEDs or sets of lights that can be turned on and off in sequence to generate different lighting conditions, a scale that is sufficiently accurate to distinguish authentic, functioning components from defective or counterfeit components, such as a scale accurate to 0.0001 grams, for example, an electrical contact matrix or set of contact pins, a rig arm, and a control board that relays information to its storage and/or processing service.

The software is composed of three intermediary functions and 13 validator functions as above. Other validator tests can be added, such as fraud checks on the supplier of the components, data on its provenance, additional electrical function tests or validation of the serial number with external parties.

The test steps can be performed and will work in any order as long as the intermediary steps are completed. The tests can be partially completed as well.

1. A device for authenticating an electronic component, comprising: at least one digital imaging device, wherein the digital imaging device outputs digital image data; at least one light for illuminating a staging area within the device, wherein the staging area is within a field of view of at least one of the at least one digital imaging device; a scale with a digital output; and a central processing unit in electrical communication with the at least one digital imaging device and the scale.

2. The device of claim 1, wherein the at least one light is a plurality of lights.

3. The device of claim 2, wherein the plurality of lights comprises at least two sets of individually controlled lights.

4. The device of claim 3, wherein the set of individually controlled lights are controlled by the central processing unit.

5. The device of claim 4, wherein the individually controlled lights are controlled during an imaging process of the digital imaging device.

6. The device of claim 1, wherein the scale is capable of measuring the weight reads the weight of an object placed.

7. The device of claim 6, wherein the scale is accurate to 0.0001 grams.

8. The device of claim 1, wherein the central processing unit is in communication with a database of chip information.

9. The device of claim 8, wherein the chip information comprises at least one of a chip identification code of the authentic electronic component, a weight range of the authentic electronic component identified by the chip identification code, a color range of the authentic electronic component identified by the chip identification code, label information of the authentic electronic component identified by the chip identification code, label placement coordinates of the label on the authentic electronic component identified by the chip identification code, a size of the authentic electronic component identified by the chip identification code, a size of various elements of the authentic electronic component identified by the chip identification code.

10. The device of claim 1, wherein the various elements may include a length, width, and height of a body, the label, characters of the label, a depth of the characters of the label, pins, solder residue, or other features of the authentic electronic component.

11. The device of claim 1, comprising a matrix of pin connections.

12. The device of claim 11, wherein each of the pin connections is individually connected to the central processing unit.

13. The device of claim 12, wherein at least a portion of the pin connectors receive an input signal from the central processing unit or a signal generator.

14. The device of claim 13, wherein at least a portion of the pin connectors output a signal to the central processing unit.

15. The device of claim 11, comprising a platform or other member to press an electronic component to the matrix to provide electrical communication between at least one pin of the electronic component to a pin connection.

16. The device of claim 15, wherein the platform or other member is pivoted by a lever arm.

17.-52. (canceled)
